(19) United States
(12) Patent Application Publication
(10) Pub. No.: US 2002/0082057 A1
(43) Pub. Date: Jun. 27, 2002

(54) System and method for utilizing mobile conmunication terminal as wireless headset

(75) Inventor: Hyoung Yoon Kim, Seoul (KR)

Correspondence Address: Daniel Y.J. Kim, P.O. Box 221200, Chantilly, VA, 20153-1200, US

(73) Assignee: LG ELECTRONICS INC.

(21) Appl. No.: 10/005,323

(22) Filed: Dec. 7, 2001

(30) Foreign Application Priority Data
Dec. 21, 2000 (KR) 79700/2000

(51) Int. Cl. H04M 1/00

(52) U.S. Cl. 455/568; 455/569; 455/41

(57) ABSTRACT

Disclosed is a system for utilizing a mobile communication terminal as a wireless headset, comprising: a personal computer (PC) adapted to access to an Internet phone service through an Internet network; and mobile communication terminal for performing a function of a wireless headset of the PC when the PC accesses the Internet phone service, wherein the mobile communication terminal have a bluetooth function. The present invention allows a user to utilize a mobile communication terminal having a Bluetooth function built therein as a wireless headset of the PC, making it possible for him/her to conveniently use an Internet phone call service. Further, when an operation mode of the mobile communication terminal is set to a headset mode, a speech signal of a user inputted through a microphone is transmitted to the PC directly via a Bluetooth device and the speech signal of a counterpart inputted to the mobile communication terminal from the PC is applied to a speaker via the Bluetooth device.

### BACKGROUND OF THE INVENTION

1. Field of the Invention

The present invention relates to a mobile communication terminal, and more particularly, a system and method for utilizing the mobile communication terminal as a wireless headset of a PC for an Internet phone service.

2. Description of the Related Art

Currently, the wide spread of an ultra-high speed Internet leads to a sharp increase in the number of Internet phone users. Each of Internet phone users access to an Internet network using a personal computer (PC), and then perform a telephone conversation with an opposite party user using a wired or wireless headset into which a microphone and a speaker are combined.

However, there has been a problem that in order to use a conventional Internet phone, a user must purchase a separate wired or wireless headset, requiring an additional cost.

Further, the wired headset is generally connected to the PC through a cable so that it can be operated. Therefore, the user suffers from a spatial limitation in that he/she must always near the PC when using the wired headset.

In the meantime, the wireless headset can overcome the spatial limitation that the wired headset possesses, but also has a disadvantage that it is more expensive and has a lower rate of spread as compared with the wired headset.

### SUMMARY OF THE INVENTION

Therefore, the present invention has been made in view of the above-mentioned problems, and it is an object of the present invention to provide a system and method for utilizing a mobile communication terminal having a high rate of spread as a wireless headset of a PC for an Internet phone call service.

According to one aspect of the present invention, there is provided a system for utilizing a mobile communication terminal as a wireless headset, comprising:

a PC adapted to access to an Internet phone service through an Internet network; and

a mobile communication terminal adapted to perform a function of the wireless headset of the PC when the PC accesses the Internet phone service, the mobile communication terminal having a Bluetooth function built therein.

The PC includes a Bluetooth card for communicating with the mobile communication terminal, and a sound card processing a speech signal inputted through the Bluetooth card. The mobile communication terminal includes a Bluetooth device for directly transmitting/receiving the speech signal to/form the Bluetooth card.

According to another aspect of the present invention, there is also a method for utilizing a mobile communication terminal as a wireless headset, comprising the steps of:

(a) setting an operating mode of the mobile communication terminal;

(b) determining whether or not the set operating mode thereof is a headset mode;

(c) changing input/output ports within the mobile communication terminal if the set operating mode is the headset mode; and

(d) transmitting a speech signal of a user inputted through a microphone to a personal computer (PC) via a Bluetooth device of the mobile communication terminal.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram illustrating the construction of a system for utilizing a mobile communication terminal as a wireless headset according to the present invention; and

FIG. 2 is a block diagram illustrating a mobile communication terminal implemented to perform a speech signal processing operation in a general call mode in FIG. 1;

FIG. 3 is a block diagram illustrating a mobile communication terminal implement to perform a speech signal processing operation in a headset mode; and

FIG. 4 is a flow chart illustrating the process routine for explaining a method of utilizing a mobile communication terminal as a wireless headset according to the present invention.

### DETAILED DESCRIPTION OF THE PREFERRED EMBODIMENT

Reference will now be made in detail to the preferred embodiments of the present invention. Throughout the drawings, it is noted that the same reference numerals or letters will be used to designate like or equivalent elements having the same function.

A Bluetooth, which is a new wireless communication technology, is a protocol that can transmit a large amount of data at a high speed through a wireless connection between a plurality of communication equipments. Therefore, many devices for supporting the Bluetooth technology have been developed, and in the case of the mobile communication terminal, terminal products embedded with a Bluetooth function are made available in the market.

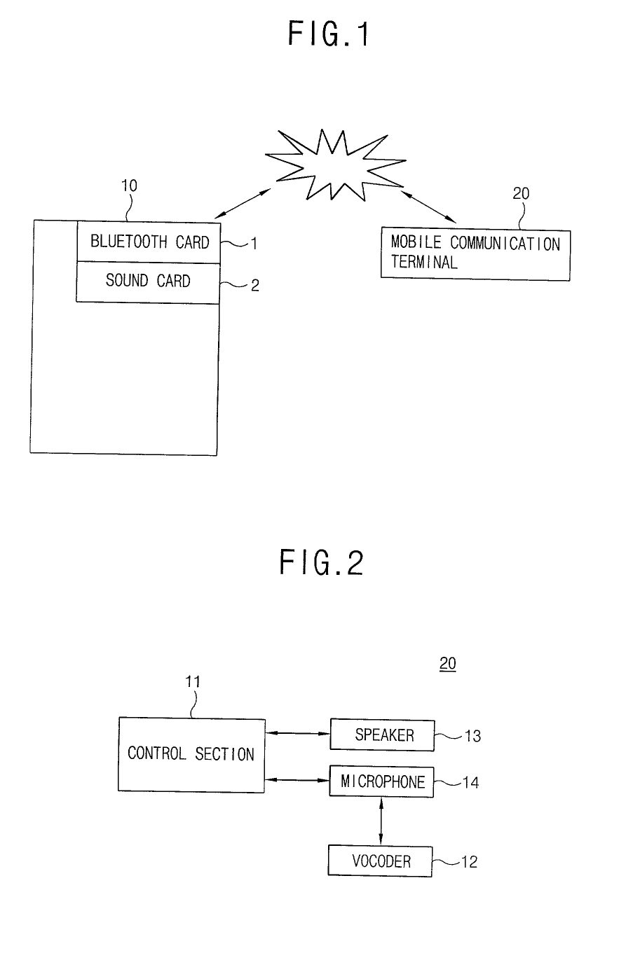

FIG. 1 is a block diagram illustrating the construction of a system for utilizing a mobile communication terminal as a wireless headset according to the present invention.

Referring to FIG. 1, the system for utilizing the mobile communication terminal as the wireless headset according to the present invention includes a PC 10 for accessing to an Internet phone service through an Internet network, and a mobile communication terminal 20 for performing a wireless headset function of the PC 10.

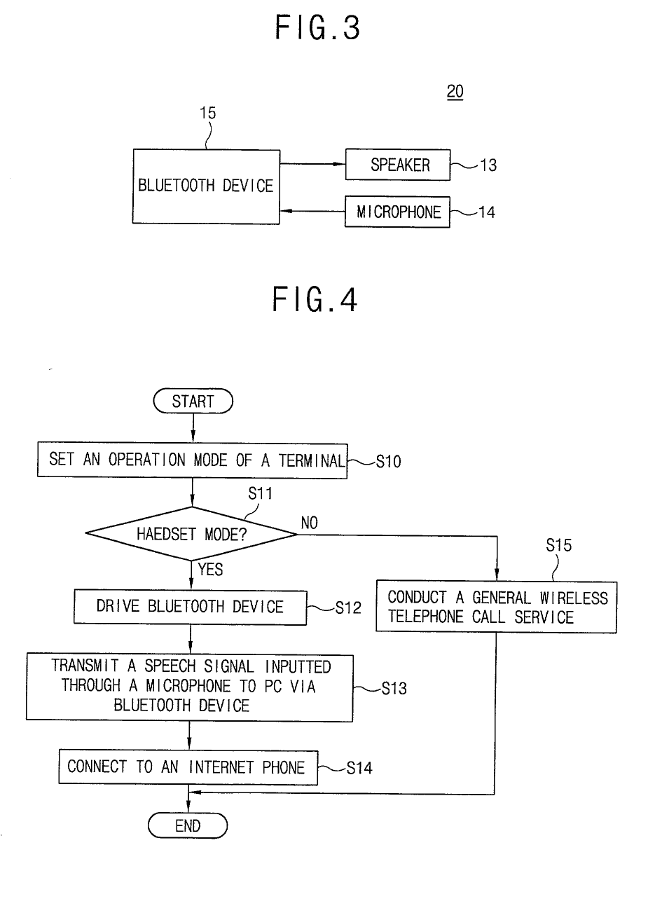

The PC 10 includes a Bluetooth card 11 for communicating with the mobile communication terminal 20, and a sound card 2 for processing a speech signal inputted thereto through the Bluetooth card 1. The mobile communication terminal 20 includes a Bluetooth device 15 for directly transmitting/receiving the speech signal to/from the Bluetooth card 1 as shown in FIG. 3.

Now, the operation of a system for utilizing a mobile communication terminal as a wireless headset according to the present invention as constructed above will be an detail described hereinafter with reference to the accompanying drawings.

The mobile communication terminal 20 (hereinafter, referred to as “terminal”) is operated in both a general call mode and a headset mode. When a user sets an operation mode of the terminal to the general call mode, a control section 11 controls a vocoder 12, a speaker 13 and a microphone 14 to process a speech signal in the same manner as that in the prior art.

In this state, the user may change the operation mode of the terminal 20 from a general call mode to a headset mode in order to utilize the terminal 20 as a wireless headset of the PC 10. When the headset mode is set by the user, a Mobile Station Modem (NSM) (not shown) of the terminal 20 sets internal functions for providing a headset function.

When the operation mode of the terminal 20 is set to the headset mode, the speech signal inputted to the terminal through a microphone 14 is transmitted to the PC 10 through the Bluetooth device 15 of the terminal 20. At this time, the speech signal received by the PC 10 is inputted to the sound card 2 through the Bluetooth card 1 of the PC 10. Therefore, the sound card 2 processes the speech signal in the same manner as that in the prior art, and then transmits the processed speech signal to the user's counterpart through an Internal line.

In the meantime, when the speech signal of the user's counterpart is transmitted to the PC 10 of the user through the Internet line, it is supplied to the terminal 20 through the sound card 2 and the Bluetooth card 1 of the PC 10. At this time, the speech signal of the counterpart inputted to the terminal 20 from the PC 10 is applied to the speaker 13 through the Bluetooth device 15 to output the speech signal to the outside. Therefore, utilization of the terminal as a wireless headset of the PC allows the user to effectively conduct an Internet phone call service.

The process of utilizing a mobile communication terminal as a wireless headset according to the present invention will be in detail described hereinafter with reference to FIG. 3.

As shown in FIG. 3, the user changes an operation mode of the terminal 20 from a general call mode to a headset mode on a user menu using a key button in a key input section of the terminal 20 (S10).

At subsequent step S11, the MSM (not shown) of the terminal 20 checks whether or not the headset mode has been set periodically or every time there is a key input for establishing an operation mode of the terminal 20. If it is determined at step S11 that the headset mode has been set by the user, the program proceeds to step S12 in which the MSM drives (enables) the Bluetooth device 15 and alters input/output ports within the terminal 20. That is, the MSN 25 performs a control function so that output ports of the speaker 13 and the microphone 14 connected to the control section 11 is connected to the Bluetooth device 15 of the terminal.

Therefore, the speech signal of the user inputted to the terminal 20 through the microphone 14 is transmitted to the PC 10 directly through Bluetooth protocol of the Bluetooth device 15, and thus the user may use an Internet phone call service using the PC 10 and the mobile communication terminal 20 (S13, S14).

On the other hand, it is determined at step S11 that the headset mode has not been set by the user, i.e. a general call mode has been set, the program proceeds to step S15 where the MSM (not shown) controls the control section 11 to allow the user to conduct a wireless telephone call service.

As can be seen from the foregoing, the present invention has an advantage in that it allows d user to utilize a mobile communication terminal having a Bluetooth function built therein as a wireless headset of a PC for an Internet phone call service, thereby overcoming the spatial limitation that a conventional wired headset possesses.

Further, the present invention allows the user to utilize the mobile communication terminal spread widely throughout the world as a wireless headset of the PC for the Internet phone call service, thereby reducing an additional cost required to purchase a conventional wireless headset.

While this invention has been described in connection with what is presently considered to be the most practical and preferred embodiment, it is to be understood that the invention is not limited to the disclosed embodiment, but, on the contrary, it is intended to cover various modifications, variations or equivalents within the spirit and scope of the depended claims.

What is claimed is:

1. A system for utilizing a mobile communication terminal as a wireless headset, comprising:
a personal computer (PC) adapted to gain access to an Internet phone service through an Internet network; and
a mobile communication terminal adapted to perform a function of a wireless headset of the PC when the PC accesses the Internet phone service, wherein the mobile communication terminal have a bluetooth function built therein.

2. The system according to claim 1, wherein the PC comprises a Bluetooth card for receiving a speech signal of a user from the mobile communication terminal and transmitting the received speech signal to a sound card.

3. The system according to claim 1, wherein the mobile communication terminal further comprises:
a speaker;
a microphone; and
a Bluetooth that transmits the speech signal inputted through the microphone to the PC using a Bluetooth protocol and outputs the speech signal transmitted from the PC to the speaker.

4. A system for utilizing a mobile communication terminal as a wireless headset, comprising:
a personal computer (PC) that accesses to an Internet phone service through an Internet network; and
a mobile communication terminal built therein a bluetooth function, which performs a function of a wireless headset of the PC when the PC accesses the Internet phone service, the mobile communication terminal including;
speaker;
a microphone; and
a Bluetooth device that transmits the speech signal inputted through the microphone to the PC using a Bluetooth protocol and outputs the speech signal transmitted from the PC to the speaker.

5. A method for utilizing a mobile communication terminal as a wireless headset, comprising the steps of:
setting an operating mode of the mobile communication terminal,
determining whether or not the set operating mode is a headset mode;
changing input/output ports of the mobile communication terminal if the set operating mode is the headset mode; and
transmitting a speech signal inputted through a microphone to a personal computer (PC) via a Bluetooth device of the mobile communication terminal.

6. The method according to claim 5, further comprising the step of accessing an Internet phone service after receiving the speech signal from the mobile communication terminal.

7. The method according to claim 5, wherein in the determining step, a normal wireless telephone call service is performed if the set operating mode is a general call mode.
